(19) United States
(12) Patent Application Publication
(10) Pub. No.: US 2021/0031662 A1
(43) Pub. Date: Feb. 4, 2021

(54) AUTOMOTIVE ACCESSORIES

(71) Applicant: Pilot Inc., City of Industry, CA (US)

(72) Inventors: Dannette Holt, Long Beach, CA (US); Shen Yuhong, Jiaxing (CN)

(21) Appl. No.: 16/525,280

(22) Filed: Jul. 29, 2019

(51) Int. Cl. B60N 3/04; B60N 2/58; C08L 9/02; C08K 5/12; C08K 5/00; C08K 3/04; C08L 101/00

(52) U.S. Cl. CPC B60N 3/048; B60N 2/58; C08L 9/02; C08L 2207/04; C08K 5/0016; C08K 3/04; C08L 101/00; C08K 5/12

(57) ABSTRACT

Automotive accessories such as floor mats and seat covers may be manufactured from a compound containing rubber and bamboo charcoal, which compound beneficially provides air-purification and anti-bacterial functions. As a result, such automotive accessories beneficially assist in the removal of odiferous and other undesirable particles from the air within the automobile interior.

### FIELD OF THE DISCLOSURE

The present disclosure relates to automotive accessories, and more particularly to automotive accessories made of a rubber—bamboo charcoal compound.

### BACKGROUND

Undesirable smells can be difficult to mask or remove within vehicles. Chemicals, toxins, volatile organic compounds, and other odiferous particles from cigarette smoke, aromatic food, paints, gasoline, chemical fabric treatments, and other sources may be easily trapped within the fabrics, carpets, and other materials within a vehicle passenger cabin. This is especially true when foods and/or liquids are spilled inside of a vehicle. Moreover, the fact that vehicle passenger cabins are generally enclosed limits the flow of fresh air through a vehicle. While an automotive vehicle HVAC system may be set to circulate fresh air, and the vehicle's windows and doors may be may be rolled down and opened, these options are not always available (depending on whether and how the vehicle is being operated), and even when available are of limited effect.

Many air fresheners have been designed that emit desirable (or at least alternative) smells in an attempt to mask any undesirable smells in a vehicle passenger cabin. These air fresheners add more aromatic particles to the vehicle interior.

### SUMMARY

Particularly given that existing options for removing smells from vehicle interiors are of limited effect, and further given that using air fresheners to add additional smells to the vehicle interior may be undesirable to some users, the present disclosure presents an alternative solution for addressing undesirable odors within a vehicle. More specifically, according to some embodiments of the present disclosure, floor mats, seat covers, and other automotive accessories may be manufacturing from a material comprising a mixture of rubber and bamboo charcoal, which material traps odiferous particles, thus removing them from the air and preventing them from reaching a vehicle occupant's olfactory receptors.

According to one embodiment of the present disclosure, a floor mat comprises a top surface; a bottom surface opposite the top surface; and an embossed pattern covering at least a portion of the top surface, wherein the floor mat is manufactured from a material comprising rubber and bamboo charcoal. The material may further comprise a plasticizer. The plasticizer may be dioctyl phthalate. The rubber may comprise a thermoplastic elastomer. The rubber may comprise a nitrile rubber. The material may comprise: about 45 wt. % thermoplastic elastomer; about 20 wt. % dioctyl phthalate; about 30 wt. % bamboo charcoal; and about 5 wt. % nitrile rubber. The material may comprise: about 50 wt. % thermoplastic elastomer; about 15 wt. % dioctyl phthalate; about 30 wt. % bamboo charcoal; and about 2 wt. % nitrile rubber. The material may comprise: at least about 40 wt. % thermoplastic elastomer; and at least about 20 wt. % bamboo charcoal.

A seat cover according to some embodiments of the present disclosure comprises at least one strap for securing the seat cover to a seat. The seat cover comprises a material comprising rubber and bamboo charcoal. The material may be elastic. The material may further comprise a plasticizer. The plasticizer may be dioctyl phthalate. The rubber may comprise a thermoplastic elastomer. The rubber may comprise a nitrile rubber. The material may comprise at least about 40 wt. % thermoplastic elastomer and at least about 10 wt. % bamboo charcoal. The material may further comprise at least about 15 wt. % plasticizer. The material may further comprise at least about 2 wt. % nitrile rubber. The material may comprise about 30 wt. % bamboo charcoal.

According to still other embodiments of the present disclosure, an automotive accessory is manufactured from a material comprising at least about 40 wt. % thermoplastic elastomer; at least about 15 wt. % dioctyl phthalate; bamboo charcoal; and at least about 2 wt. % nitrile rubber. The material may comprise about 50 wt. % thermoplastic elastomer; and about 30 wt. % bamboo charcoal. The material may comprise about 50 wt. % thermoplastic elastomer; about 15 wt. % dioctyl phthalate; about 30 wt. % bamboo charcoal; and about 5 wt. % nitrile rubber.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Z₀, the phrase is intended to refer to a single element selected from X, Y, and Z, a combination of elements selected from the same class (e.g., X₁ and X₂) as well as a combination of elements selected from two or more classes (e.g., Y₁ and Z₀).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a block diagram showing the composition of a material that may be used in embodiments of the present disclosure;

FIG. 2A is a top view of a vehicle floor mat according to embodiments of the present disclosure;

FIG. 2B is a bottom view of a vehicle floor mat according to embodiments of the present disclosure; and

FIG. 3 is a vehicle seat cover according to embodiments of the present disclosure.

### DETAILED DESCRIPTION

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure. “Approximately” and “about” mean within plus or minus up to 10% of a stated value or range of values. For example, “approximately 100” may encompass 90 (which is 100 minus 10% of 100) to 110 (which is 100 plus 10% of 100), and “approximately 40-50” may encompass 36 (which is 40 minus 10% of 40) to 55 (which is 50 plus 10% of 50). The string “wt. %” should be understood to mean percent by weight.

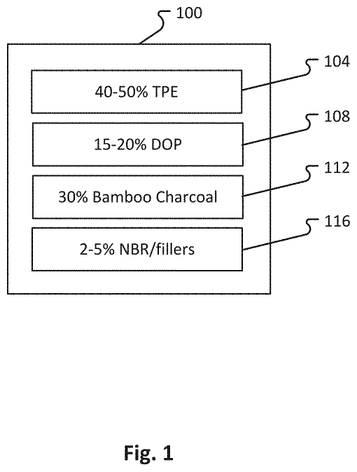

Referring first to FIG. 1, a rubber-bamboo charcoal compound 100 may comprise approximately 40-50 wt. % thermoplastic elastomer (TPE) 104, approximately 15-20 wt. % dioctyl phthalate (DOP) 108, approximately 30 wt. % bamboo charcoal 112, and approximately 2-5 wt. % nitrile rubber (also known as acrylonitrile butadiene rubber or NBR) 116. To the extent the foregoing materials are not present in sufficient quantities for the total percentage thereof to reach 100 wt. %, filler and/or incidental materials may be included as well so that the total percentage of all materials included in the compound 100 is 100 wt. %.

The thermoplastic elastomer 104 may be a styrenic block copolymer, a thermoplastic plyolefinelastomer, a thermoplastic vulcanizate, a thermoplastic polyurethane, a thermoplastic copolyester, a thermoplastic polyamide, and/or any other thermoplastic elastomer. The thermoplastic elastomer 104 may have the ability to be stretched to moderate elongations and then return to its original shape (or close to its original shape). The thermoplastic elastomer 104 may further be processable as a melt at elevated temperature. Indeed, manufacture of the compound 100 may comprise melting the thermoplastic elastomer so that it can be mixed with the other ingredients of the compound 100, including the DOP, bamboo charcoal, and nitrile rubber. Still further, the thermoplastic elastomer 104 may be resistant to creep or may not demonstrate any creep.

The dioctyl phthalate 108 is used as a plasticizer in the compound 100 to increase softness and flexibility. In some embodiments, a plasticizer other than DOP may be used in the compound 100. For example, the compound 100 may alternatively use diisononyl phthalate, diisodecyl phthalate, dioctyl terephthalate, di-2-propyl heptyl phthalate, 1,2-cyclohexane dicarboxylic acid diisononyl ester, and/or citrate esters.

With respect to the bamboo charcoal 112 in particular, bamboo charcoal is filled with micro-holes that effectively absorb odiferous particles as well as sweat and moisture. The bamboo charcoal 112 thus traps toxins and other chemicals, preventing them from circulating through the air. Moreover, bamboo charcoal has anti-bacterial properties as well, and thus helps to prevent bacteria colonies from growing inside the vehicle.

While possessing beneficial properties, bamboo charcoal alone is not always suitable for stand-alone use, given its brittle, inelastic nature and low durability. To overcome these deficiencies for use in automotive accessories, the compound 100 further comprises the TPE 104, DOP 108, and NBR and other fillers 116. These materials provide elasticity, resilience, strength, durability, and other beneficial properties while also supporting pieces and/or particles of the bamboo charcoal 112. As a result, the compound 100 advantageously provides the beneficial properties of the bamboo charcoal 112 while being suitable for use in applications—including, for example, the automotive applications discussed herein—that require other beneficial characteristics not found in bamboo charcoal.

The NBR 116 may increase the resistance of the compound 100 to chemicals such as oils and fuels, and may also increase the strength and resilience of the compound 100. In some embodiments, the NBR 116 may be or comprise one or more unsaturated copolymers of 2-propenenitrile and various butadiene monomers, such as 1,2-butadiene and 1,3-butadiene. Also in some embodiments, the NBR 116 may be or comprise hydrogenated nitrile butadiene rubber (HNBR) and/or carboxylated nitrile butadiene rubber (XBNR). In some embodiments, the NBR 116 may comprise other fillers, and in some embodiments, other fillers may be substituted for the NBR 116 altogether (e.g., such that the compound 100 comprises 2-5 wt. % non-NBR fillers).

According to embodiments of the present disclosure, filler or incidental materials may include any material that does not eliminate the desired properties of the compound 100, including the air-purification and anti-bacterial functions of the bamboo charcoal 112. The filler or incidental materials may include solids and/or liquids. The incidental material may be, for example, organic fillers, mineral fillers, proteid fillers, and textiles or other fibrous matter. In some embodiments, for example, the compound 100 may utilize one or more of sand, silica, gypsum, and/or cotton as filler material.

In one embodiment, a compound 100 comprises approximately 40 wt. % TPE, approximately 20 wt. % DOP, approximately 30 wt. % bamboo charcoal, approximately 5 wt. % NBR, with other filler or incidental materials making up the remainder of the compound 100.

In another embodiment, a compound 100 comprises approximately 45 wt. % TPE, approximately 20 wt. % DOP, approximately 30 wt. % bamboo charcoal, and approximately 5 wt. % NBR and/or other fillers.

In still another embodiment, a compound 100 comprises approximately 50 wt. % TPE, approximately 15 wt. % DOP, approximately 30 wt. % bamboo charcoal, and approximately 5 wt. % NBR and/or other fillers.

In still another embodiment, a compound 100 comprises approximately 50 wt. % TPE, approximately 15 wt. % DOP, approximately 30 wt. % bamboo charcoal, and at least approximately 2 wt. % NBR, with other filler or incidental materials making up the remainder of the compound 100.

In still another embodiment, a compound 100 comprises approximately 50 wt. % TPE, approximately 18 wt. % DOP, approximately 30 wt. % bamboo charcoal, and at least approximately 2 wt. % NBR and/or other fillers.

In still another embodiment, a compound 100 comprises approximately 48 wt. % TPE, approximately 20 wt. % DOP, approximately 30 wt. % bamboo charcoal, and at least approximately 2 wt. % NBR and/or other fillers.

Subranges of the amounts of TPE, DOP or other plasticizer, nitrile rubber, filler or incidental materials, and bamboo charcoal or other carbon material identified in the foregoing discussion are contemplated by this disclosure although not specifically listed.

Various benefits of the compound 100 described above, including the anti-bacterial properties thereof and the air purification properties thereof, have been confirmed through product testing. In one air purification test, a compound 100 according to an embodiment of the present disclosure absorbed 606 negative oxygen ions per cubic centimeter. In a test of the absorption of VOCs, the compound 100 removed 60.5 wt. % of airborne formaldehyde VOCs in a given volume. In still another test, the compound 100 was shown to essentially eliminate all Escherichia coli and Staphylococcus aureus bacteria applied to its surface over a 24-hour period.

Other compounds according to embodiments of the present disclosure may be formulated differently than the compound 100. In some embodiments, a compound according to embodiments of the present disclosure comprises between approximately 0 wt. % and 50 wt. % thermoplastic elastomer. For example, the amount of TPE can be 0 wt. % or about 5 wt. %, 10 wt. %, 15 wt. %, 20 wt. %, 25 wt. %, 30 wt. %, 35 wt. %, 40 wt. %, 45 wt. %, or 50 wt. %.

Also in some embodiments, a compound according to embodiments of the present disclosure comprises between approximately 0 wt. % and 20 wt. % DOP. For example, the amount of DOP can be 0 wt. % or about 5 wt. %, 10 wt. %, 15 wt. %, or 20 wt. %.

Also in some embodiments, a compound according to embodiments of the present disclosure comprises between approximately 10 wt. % and 40 wt. % of a carbon material, whether bamboo charcoal or another carbon material. For example, the amount of carbon material can be about 10 wt. %, 15 wt. %, 20 wt. %, 25 wt. %, 30 wt. %, 35 wt. %, or 40 wt. %.

Also in some embodiments, a compound according to embodiments of the present disclosure comprises between approximately 0 wt. % and 5 wt. % of nitrile rubber. For example, the amount of nitrile rubber may be 0 wt. %, or about 1 wt. %, 2 wt. %, 3 wt. %, 4 wt. %, or 5 wt. %.

Also in some embodiments, a compound 100 according to embodiments of the present disclosure between approximately 0 wt. % and 5 wt. % of filler material other than nitrile rubber. For example, the amount of filler material may be 0 wt. %, or about 1 wt. %, 2 wt. %, 3 wt. %, 4 wt. %, or 5 wt. %.

In some embodiments, a compound may comprise approximately 10 wt. % bamboo charcoal and approximately 90 wt. % rubber compounds. In other embodiments, a compound may comprise approximately 20 wt. % bamboo charcoal and approximately 80 wt. % rubber compounds. In still other embodiments, a compound may comprise approximately 30 wt. % bamboo charcoal and approximately 70 wt. % rubber compounds. In further embodiments, a compound may comprise approximately 40 wt. % bamboo charcoal and approximately 60 wt. % rubber compounds. Rubber compounds may include one or more of any species of TPE and/or NBR. Any of the foregoing embodiments may also comprise up to approximately 20 wt. % of DOP or other plasticizer, with a corresponding reduction in amount of the other component materials of the compound.

Also in some embodiments, a compound according to embodiments of the present disclosure may comprise at least approximately 40 wt. % TPE, and at least approximately 10 wt. % bamboo charcoal.

A compound according to other embodiments of the present disclosure may comprise at least about 40 wt. % TPE and at least about 20 wt. % bamboo charcoal.

A compound according to any of the foregoing embodiments may comprise at least about 15 wt. % plasticizer.

A compound according to any of the foregoing embodiments may comprise at least about 2 wt. % nitrile rubber.

A compound according to still other embodiments of the present disclosure may comprise at least about 40 wt. % TPE and at least about 30 wt. % bamboo charcoal.

Subranges of the amounts of TPE, DOP or other plasticizer, nitrile rubber, filler or incidental materials, and bamboo charcoal or other carbon material identified in the foregoing discussion are contemplated by this disclosure although not specifically listed.

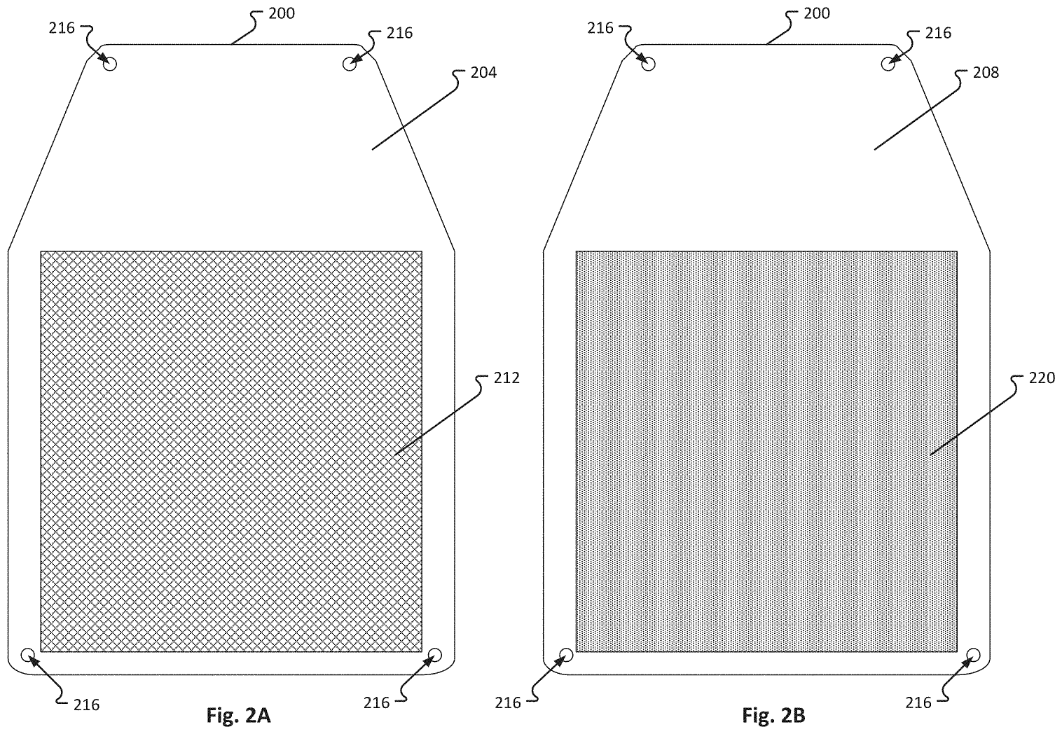

Turning now to FIGS. 2A-2B, a vehicle floor mat 200 may be manufactured entirely or partially from the compound 100 or a similar rubber—bamboo charcoal compound. The floor mat 200 comprises a top surface 204 and a bottom surface 208. An embossed pattern 212 may be provided on some or all of the top surface 204, whether for purely ornamental purposes and/or to improve traction (e.g., to prevent an occupant from slipping on the mat(s) 200 when the mat 200 and/or the shoes or feet of the occupant are wet or otherwise have a low coefficient of friction).

In some embodiments, the mat 200 may comprise one or more holes 216 around the perimeter of the mat 200 that are engageable with a post or mechanism protruding from the vehicle floor to hold the mat 200 in position. While the mat 200 depicted in FIGS. 2A-2B comprises four holes 216, in other embodiments the mat 200 may comprise no holes 216, one hole 216, or any other desired number of holes 216. Also in some embodiments, the mat 200 may comprise a bottom liner 220 having a high coefficient of friction to prevent the mat 200 from slipping relative to the floor of the vehicle in which the mat 200 is used or installed. In still other embodiments, the mat 200 may comprise one or more snaps, hook-and-loop materials such as Velcro, high-friction coatings or surfaces, and/or other devices, fabrics, coatings, treatments, or means for keeping the mat 200 in a desired position on the vehicle floor.

Although the vehicle floor mat 200 illustrated in FIGS. 2A-2B has a particular shape, vehicle floor mats according to the present disclosure may be any size or shape, and may be configured to be placed on any interior floor surface of a vehicle. For example, the vehicle floor mat 200 may be configured to be placed on a car floor in front of the driver's seat (e.g., under a driver's feet); on a car floor in front of the front passenger's seat (e.g., under a front passenger's feet); on a car floor in front of a middle row or an individual middle row seat (e.g., under the feet of one or more middle row passengers); on a car floor in front of a back row or individual back row seat (e.g., under the feet of one or more back row passengers); and/or on a car floor behind the back row seats (e.g., in the trunk).

Because the vehicle floor mat 200 comprises a significant portion of rubber compound, the floor mat 200 may protect the car floor against water, mud, liquid and food spills, and other substances or events that might damage the finish of the car floor. Moreover, because the vehicle floor mat 200 comprises a significant portion of bamboo charcoal, the floor mat 200 has air purification and anti-bacterial properties. These properties enable the floor mat 200 to deodorize the vehicle by removing odiferous/aromatic particles (including any of the types of particles discussed herein and/or other odiferous/aromatic particles) from the air. Removal of such particles is advantageous to simply masking the odors resulting from such particles by releasing additional aromatic particles into the air. The floor mat 200 further functions to remove toxic and other foreign particles from the air. These properties further improve the cleanliness of the vehicle, including by helping to clean the air of pollutants and by preventing bacteria growth on the mat 200. The greater the surface area of the mat(s) 200 being used (whether that surface area is obtained by using larger mats 200 or a greater number of mats 200), the greater will be the ability of the mat(s) 200 to deodorize and clean the vehicle interior.

In some embodiments, the mat 200 may be layered, with one or more layers of the compound 100 or a similar compound. In other embodiments, the mat 200 may be molded, cut, or otherwise fashioned as a single, integral piece. The thickness of the mat 200 may be, for example, between one quarter inch and two inches.

Providing a vehicle floor mat 200 comprising the compound 100 enables the retrofitting of vehicles with one or more floor mats 200 providing the beneficial air-purification and anti-bacterial properties of the compound 100. However, in some embodiments, the compound 100 or a similar compound may be used in the initial manufacture of a vehicle, for example by manufacturing all or portions of a floor of a vehicle, a lining of a vehicle floor, a dashboard, or any other interior paneling, molding, or lining from the compound 100.

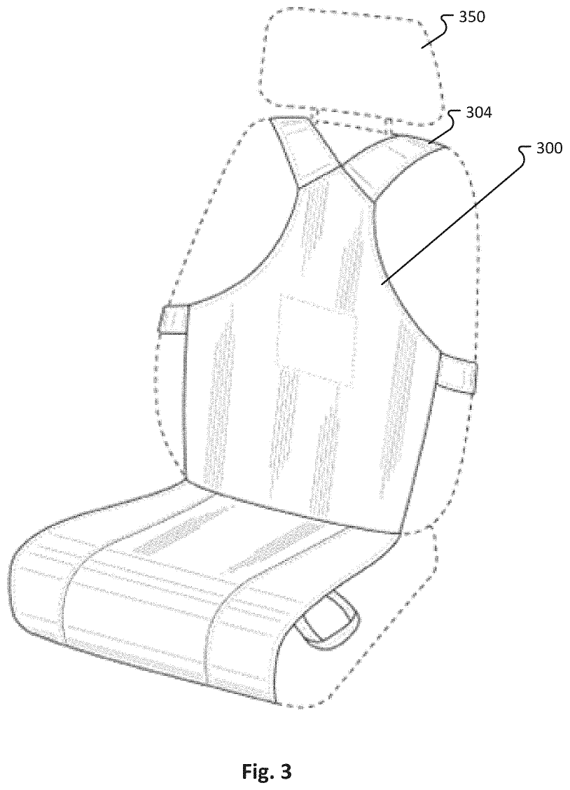

FIG. 3 shows a seat cover 300 according to embodiments of the present disclosure. The seat cover 300, which is configured to be secured to a vehicle seat 350 (whether via straps 304 or otherwise), is made entirely or partially of the compound 100 or a similar compound. In some embodiments, the seat cover 300 is elastic, and is manufactured to stretch over a vehicle seat 350 and to rely on the elasticity thereof to remain in position. In other embodiments, including the embodiment depicted in FIG. 3, the seat cover 300 is less elastic or is inelastic, and is configured to be removably secured to the seat 350 by one or more straps, snaps, ties, hook-and-loop materials such as Velcro, and/or other means.

In some embodiments, the seat cover 300 does not entirely cover the seat 350, as depicted in FIG. 3. In other embodiments, a seat cover 300 may cover at least the entire visible portion of the seat 350. The seat cover 300 may be designed for a specific seat or seat type, or the seat cover 300 may be designed to generically fit two or more seats or seat types. In some embodiments, the seat cover 300 may be sized and configured for use with a protective seat (e.g., an infant or toddler car seat or booster seat). The seat cover 350 may be waterproof.

Providing a vehicle seat cover 300 comprising the compound 100 enables the retrofitting of vehicles with a seat cover 300 that provides the beneficial air-purification and anti-bacterial properties of the compound 100. However, in some embodiments, the compound 100 or a similar compound may be used in the initial manufacture of the vehicle seats 350, for example in the upholstery of the seat 350 and/or in the internal padding or molding of the seat 350.

The seat cover 300 protects the vehicle seat 350 from damage due to water and other liquids, food, dirt, and from any number of other potential harms. The seat cover 300, as well as the floor mats 200, may be particularly well-suited for use in vehicles used to transport one or more children, who may be more prone to spilling liquids, dropping and/or hoarding foods, and/or otherwise causing damage to the vehicle floor(s) and/or seats.

Moreover, beyond providing physical protection against damage, the bamboo charcoal within the floor mats 200 and the seat covers 300 beneficially operates to remove foreign particles (including odiferous/aromatic compounds and VOCs) from the air, thus reducing, and in some cases eliminating, undesirable smells from the vehicle interior. Moreover, the bamboo charcoal further operates to reduce bacteria growth on the surface thereof, which may be particularly beneficial when, for example, a substance that is likely to foster bacteria growth, such as milk, spills on the seat cover 300 or the floor mat 200.

Although the present disclosure focuses on the use of a compound 100 in a floor mat 200 and in a seat cover 300, the compound 100 or a similar compound may be used for other automotive accessories as well, and particularly for other automotive accessories intended to be used in a vehicle passenger cabin and/or trunk. Such accessories may include, for example, shades, dashboard covers, cargo liners, organizers, steering wheels, and steering wheel covers. Moreover, replacement parts (e.g., parts designed to be installed in place of OEM parts) such as interior molding and interior panels may also be made of the compound 100 or a similar compound.

Although embodiments of the foregoing disclosure have been described in connection with vehicles such as automobiles, floor mats such as the floor mats 200, seat covers such as the seat covers 300, and other accessories comprising the compound 100 or a similar compound, all for use in vehicles other than automobiles, are also included within the scope of the present disclosure. For example, floor mats, seat covers, cargo liners, and other accessories for use in airplanes, boats, trains, and spacecraft may be manufactured from the compound 100 or a similar compound.

Moreover, although the present disclosure has focused on the use of articles made of the compound 100 in vehicles, in some embodiments, the compound 100 may be used to manufacture items for use in households, offices, private and public restrooms, barns, industrial manufacturing and/or warehousing facilities, and any other location where undesirable smells may be introduced and/or present and where the air purification and/or anti-bacterial functions of the compound 100 would be beneficial.

A number of variations and modifications of the foregoing disclosure can be used. It would be possible to provide for some features of the disclosure without providing others.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A floor mat comprising:
a top surface;
a bottom surface opposite the top surface; and
an embossed pattern covering at least a portion of the top surface,
wherein the floor mat is manufactured from a material comprising:
rubber; and
bamboo charcoal.

2. The floor mat of claim 1, wherein the material further comprises a plasticizer.

3. The floor mat of claim 2, wherein the plasticizer is dioctyl phthalate.

3. The floor mat of claim 1, wherein the rubber comprises a thermoplastic elastomer.

4. The floor mat of claim 1, wherein the rubber comprises a nitrile rubber.

5. The floor mat of claim 1, wherein the material comprises:
about 45 wt. % thermoplastic elastomer;
about 20 wt. % dioctyl phthalate;
about 30 wt. % bamboo charcoal; and
about 5 wt. % nitrile rubber.

6. The floor mat of claim 1, wherein the material comprises:
about 50 wt. % thermoplastic elastomer;
about 15 wt. % dioctyl phthalate;
about 30 wt. % bamboo charcoal; and
about 2 wt. % nitrile rubber.

7. The floor mat of claim 1, wherein the material comprises:
at least about 40 wt. % thermoplastic elastomer; and
at least about 20 wt. % bamboo charcoal.

8. A seat cover comprising:
at least one strap for securing the seat cover to a seat,
wherein the seat cover comprises a material comprising:
rubber; and
bamboo charcoal.

9. The seat cover of claim 8, wherein the material is elastic.

10. The seat cover of claim 8, wherein the material further comprises a plasticizer.

11. The seat cover of claim 10, wherein the plasticizer is dioctyl phthalate.

12. The seat cover of claim 8, wherein the rubber comprises a thermoplastic elastomer.

13. The seat cover of claim 8, wherein the rubber comprises a nitrile rubber.

14. The seat cover of claim 8, wherein the material comprises:
at least about 40 wt. % thermoplastic elastomer; and
at least about 10 wt. % bamboo charcoal.

15. The seat cover of claim 14, wherein the material further comprises at least about 15 wt. % plasticizer.

16. The seat cover of claim 14, wherein the material further comprises at least about 2 wt. % nitrile rubber.

17. The seat cover of claim 8, wherein the material comprises about 30 wt. % bamboo charcoal.

18. An automotive accessory manufactured from a material comprising:
at least about 40 wt. % thermoplastic elastomer;
at least about 15 wt. % dioctyl phthalate;
bamboo charcoal; and
at least about 2 wt. % nitrile rubber.

19. The automotive accessory of claim 18, wherein the material comprises:
about 50 wt. % thermoplastic elastomer; and
about 30 wt. % bamboo charcoal.

20. The automotive accessory of claim 18, wherein the material comprises:
about 50 wt. % thermoplastic elastomer;
about 15 wt. % dioctyl phthalate;
about 30 wt. % bamboo charcoal; and
about 5 wt. % nitrile rubber.
